(19) United States
(12) Patent Application Publication
(10) Pub. No.: US 2022/0303757 A1
(43) Pub. Date: Sep. 22, 2022

(54) METHODS AND APPARATUSES FOR TRACING OF TERMINAL DEVICE

(71) Applicant: Telefonaktiebolaget LM Ericsson (publ), Stockholm (SE)

(72) Inventor: Hongxia Long, Shanghai (CN)

(21) Appl. No.: 17/606,676

(22) PCT Filed: Nov. 6, 2019
(86) PCT No.: PCT/CN2019/115982

§ 371 Date: Oct. 26, 2021

(30) Foreign Application Priority Data
Apr. 26, 2019 (CN) PCT/CN2019/084643

(51) Int. Cl. H04W 8/20

(52) U.S. Cl. CPC H04W 8/205

(57) ABSTRACT

Methods and apparatuses for tracing of a terminal device are disclosed. According to an embodiment, a network function (NF) service provider receives, from an NF service consumer, a first request for subscription data of a terminal device. The NF service provider obtains the subscription data. The subscription data comprises information related to trace requirement(s) applicable to the terminal device. The NF service provider sends the subscription data to the NF service consumer.

### TECHNICAL FIELD

Embodiments of the disclosure generally relate to communication, and, more particularly, to methods and apparatuses for tracing of a terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

The 5th generation system (5GS) supports tracing as described in the 3rd generation partnership project (3GPP) technical specification (TS) 32.421 V15.0.0. The 5GS support may include subscriber tracing (e.g. tracing targeting a subscription permanent identifier (SUPI)) or equipment tracing (e.g. tracing targeting a permanent equipment identifier (PEI)) but also other forms of tracing further described in TS 32.421. The content of trace requirements about a user equipment (UE) (e.g. trace reference, address of the trace collection entity, etc.) is defined in TS 32.421.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for tracing of a terminal device.

According to a first aspect of the disclosure, there is provided a method in a network function (NF) service provider. The method may comprise receiving, from an NF service consumer, a first request for subscription data of a terminal device. The method may further comprise obtaining the subscription data. The subscription data may comprise information related to trace requirement(s) applicable to the terminal device. The method may further comprise sending the subscription data to the NF service consumer.

In this way, the subscription data about trace requirement(s) can be provided to fulfill the requirement of the NF service consumer.

In an embodiment of the disclosure, the information related to the trace requirement(s) may comprise at least one trace requirement about the terminal device.

In an embodiment of the disclosure, the information related to the trace requirement(s) may comprise an identifier of at least one trace requirement shared among a group of terminal devices including the terminal device.

In an embodiment of the disclosure, the method may further comprise, in response to a trigger event indicating that the information related to the trace requirement(s) has been changed, sending the changed information related to the trace requirement(s) to the NF service consumer.

In an embodiment of the disclosure, obtaining the subscription data may comprise sending, to a repository node, a second request for the subscription data of the terminal device. Obtaining the subscription data may further comprise receiving the subscription data from the repository node.

In an embodiment of the disclosure, the trigger event may be a first event that the changed information related to the trace requirement(s) is received from the repository node.

In an embodiment of the disclosure, obtaining the subscription data may comprise determining the subscription data for the NF service consumer.

In an embodiment of the disclosure, the trigger event may be a second event that the NF service provider determines that the information related to the trace requirement(s) has been changed.

In an embodiment of the disclosure, the first request may be a GET message and the subscription data may be sent in a “200 OK” message.

In an embodiment of the disclosure, the changed information related to the trace requirement(s) may be sent in a POST request.

In an embodiment of the disclosure, the repository node may be a unified data repository (UDR).

In an embodiment of the disclosure, the NF service consumer may be one of: an access and mobility management function (AMF); a short message service function (SMSF); and a session management function (SMF).

In an embodiment of the disclosure, the NF service provider may be a unified data management (UDM).

According to a second aspect of the disclosure, there is provided a method in an NF service consumer. The method may comprise sending, to an NF service provider, a request for subscription data of a terminal device. The method may further comprise receiving the subscription data from the NF service provider. The subscription data may comprise information related to trace requirement(s) applicable to the terminal device.

In this way, the subscription data about trace requirement(s) can be obtained to fulfill the requirement of the NF service consumer.

In an embodiment of the disclosure, the information related to the trace requirement(s) may comprise at least one trace requirement about the terminal device.

In an embodiment of the disclosure, the information related to the trace requirement(s) may comprise an identifier of at least one trace requirement shared among a group of terminal devices including the terminal device.

In an embodiment of the disclosure, the method may further comprise receiving, from the NF service provider, changed information related to the trace requirement(s).

In an embodiment of the disclosure, the request may be a GET message and the subscription data may be received in a “200 OK” message.

In an embodiment of the disclosure, the changed information related to the trace requirement(s) may be received in a POST request.

According to a third aspect of the disclosure, there is provided a method in a repository node. The method may comprise receiving, from an NF service provider, a request for subscription data of a terminal device. The method may further comprise providing the subscription data to the NF service provider. The subscription data may comprise information related to trace requirement(s) applicable to the terminal device.

In this way, the subscription data about trace requirement(s) can be provided to fulfill the requirement of the NF service consumer.

In an embodiment of the disclosure, the information related to the trace requirement(s) may comprise at least one trace requirement about the terminal device.

In an embodiment of the disclosure, the information related to the trace requirement(s) may comprise an identifier of at least one trace requirement shared among a group of terminal devices including the terminal device.

In an embodiment of the disclosure, the method may further comprise determining whether the information related to the trace requirement(s) has been changed. The method may further comprise, when determining that the information related to the trace requirement(s) has been changed, sending the changed information related to the trace requirement(s) to the NF service provider.

According to a fourth aspect of the disclosure, there is provided an NF service provider. The NF service provider may comprise at least one processor and at least one memory. The at least one memory may contain instructions executable by the at least one processor, whereby the NF service provider may be operative to receive, from an NF service consumer, a first request for subscription data of a terminal device. The NF service provider may be further operative to obtain the subscription data. The subscription data may comprise information related to trace requirement(s) applicable to the terminal device. The NF service provider may be further operative to send the subscription data to the NF service consumer.

In an embodiment of the disclosure, the NF service provider may be operative to perform the method according to the above first aspect.

According to a fifth aspect of the disclosure, there is provided an NF service consumer. The NF service consumer may comprise at least one processor and at least one memory. The at least one memory may contain instructions executable by the at least one processor, whereby the NF service consumer may be operative to send, to an NF service provider, a request for subscription data of a terminal device. The NF service consumer may be further operative to receive the subscription data from the NF service provider. The subscription data may comprise information related to trace requirement(s) applicable to the terminal device.

In an embodiment of the disclosure, the NF service consumer may be operative to perform the method according to the above second aspect.

According to a sixth aspect of the disclosure, there is provided a repository node. The repository node may comprise at least one processor and at least one memory. The at least one memory may contain instructions executable by the at least one processor, whereby the repository node may be operative to receive, from an NF service provider, a request for subscription data of a terminal device. The repository node may be further operative to provide the subscription data to the NF service provider. The subscription data may comprise information related to trace requirement(s) applicable to the terminal device.

In an embodiment of the disclosure, the repository node may be operative to perform the method according to the above third aspect.

According to a seventh aspect of the disclosure, there is provided a computer program product. The computer program product may comprise instructions which when executed by at least one processor, cause the at least one processor to perform the method according to any of the above first to third aspects.

According to an eighth aspect of the disclosure, there is provided a computer readable storage medium. The computer readable storage medium may comprise instructions which when executed by at least one processor, cause the at least one processor to perform the method according to any of the above first to third aspects.

According to a ninth aspect of the disclosure, there is provided an NF service provider. The NF service provider may comprise a reception module for receiving, from an NF service consumer, a first request for subscription data of a terminal device. The NF service provider may further comprise an obtaining module for obtaining the subscription data. The subscription data may comprise information related to trace requirement(s) applicable to the terminal device. The NF service provider may further comprise a sending module for sending the subscription data to the NF service consumer.

According to a tenth aspect of the disclosure, there is provided an NF service consumer. The NF service consumer may comprise a sending module for sending, to an NF service provider, a request for subscription data of a terminal device. The NF service consumer may further comprise a reception module for receiving the subscription data from the NF service provider. The subscription data may comprise information related to trace requirement(s) applicable to the terminal device.

According to a eleventh aspect of the disclosure, there is provided a repository node. The repository node may comprise a reception module for receiving, from an NF service provider, a request for subscription data of a terminal device. The repository node may further comprise a provision module for providing the subscription data to the NF service provider. The subscription data may comprise information related to trace requirement(s) applicable to the terminal device.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 illustrates the existing process for requesting access and mobility subscription data of a terminal device;

FIG. 2 illustrates the existing process for requesting SMS management subscription data of a terminal device;

FIG. 3 illustrates the existing process for requesting session management subscription data of a terminal device;

FIG. 4 is a diagram showing an exemplary communication system into which an embodiment of the disclosure is applicable;

FIG. 5 is a flowchart illustrating a method implemented at an NF service provider according to an embodiment of the disclosure;

FIG. 6 is a flowchart for explaining the method of FIG. 5;

FIG. 7 is a flowchart illustrating a method implemented at an NF service consumer according to an embodiment of the disclosure;

FIG. 8 is a flowchart illustrating a method implemented at a repository node according to an embodiment of the disclosure;

FIG. 9 is a flowchart illustrating an exemplary process according to an embodiment of the disclosure;

FIG. 10 is a flowchart illustrating another exemplary process according to an embodiment of the disclosure;

FIG. 11 is a block diagram showing an apparatus suitable for use in practicing some embodiments of the disclosure;

FIG. 12 is a block diagram showing an NF service provider according to an embodiment of the disclosure;

FIG. 13 is a block diagram showing an NF service consumer according to an embodiment of the disclosure; and

FIG. 14 is a block diagram showing a repository node according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

3GPP TS 23.501/TS 23.502/TS 23.503 describe how 5GS signalling supports delivery of trace requirements about a UE (signalling based activation/deactivation of tracing). As described in TS 23.501 V16.0.2, trace requirements about a UE may be configured in subscription data of the UE and delivered together with other subscription data by the UDM towards the AMF, the SMF and/or the SMSF. Signalling based activation/deactivation of tracing is limited to public land mobile networks (PLMNs) of a single operator. Trace requirements are not delivered between visited SMF (V-SMF) and home SMF (H-SMF) or not provided by the UDM to an AMF/SMF/SMSF of a non-equivalent (H)PLMN.

The AMF propagates trace requirements about a UE received from the UDM to network entities not retrieving subscription information from UDM, i.e. to the 5G-access network (AN), to the authentication server function (AUSF) and to the policy control function (PCF). The AMF also propagates trace requirements to the SMF and to the SMSF. Trace requirements about a UE may be sent by the AMF to the 5G-AN as part of: the N2 procedures used to move the UE from connection management (CM)-IDLE to CM-CONNECTED; or the N2 procedures to request a hand-over from a target next generation-radio access network (NG-RAN); or a stand-alone dedicated N2 procedure when tracing is activated while the UE is CM-CONNECTED. Trace requirements about a UE sent to a 5G-AN shall not contain information on the SUPI or on the PEI of the UE. Trace requirements are directly sent from source to target NG-RAN in case of Xn hand-over.

The SMF propagates trace requirements about a UE received from the UDM to the user plane function (UPF) (over N4) and to the PCF. The SMF provides trace requirements to the PCF when it has selected a different PCF than the one received from the AMF. Once the SMF or the SMSF has received subscription data, trace requirements received from UDM supersede trace requirements received from the AMF. Trace requirements are exchanged on N26 between the AMF and the MME.

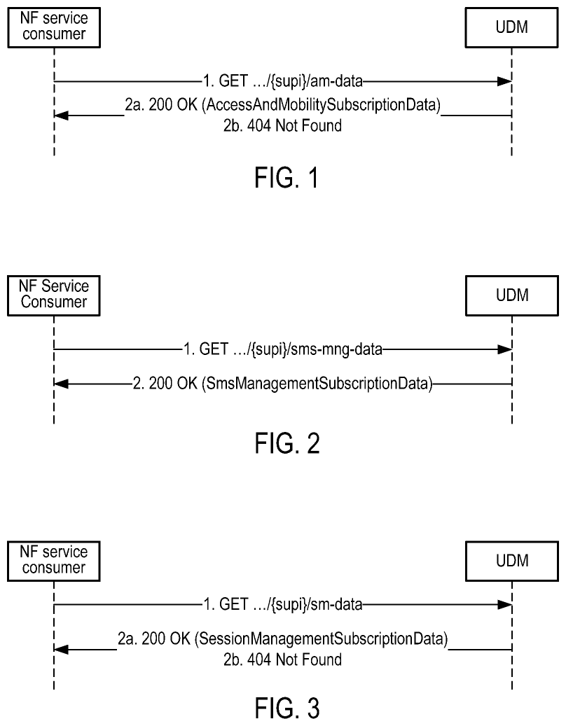

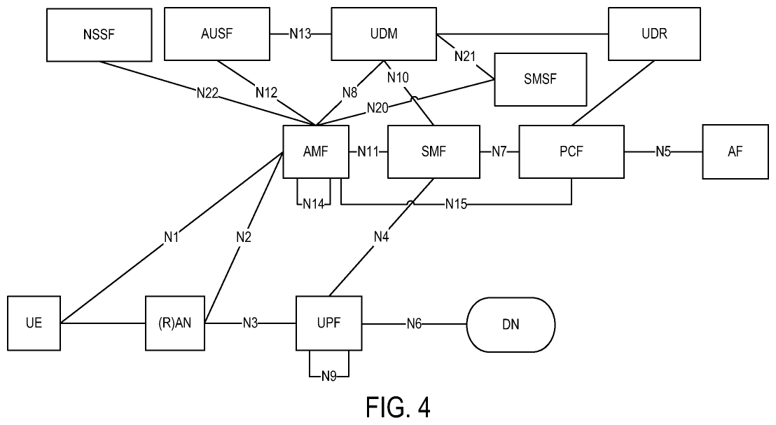

FIG. 1 shows a scenario where the NF service consumer (e.g. AMF) sends a request to the UDM to receive the UE's access and mobility subscription data (see also 3GPP TS 23.502 V16.0.2, FIG. 4.2.2.2.2-1, step 14). At step 1, the NF service consumer (e.g. AMF) sends a GET request to the resource representing the UE's access and mobility subscription data, with query parameters indicating the supported-features and/or plmn-id. The request may contain the UE's identity (I{supi}), the type of the requested information (/am-data) and query parameters (supported-features, plmn-id). At step 2a, on success, the UDM responds with “200 OK” with the message body containing the UE's access and mobility subscription data as relevant for the requesting NF service consumer. The definition about the data type “AccessAndMobilitySubscriptionData” can be obtained from Table 6.1.6.2.4-1 of TS 29.503 V15.3.0. At step 2b, on failure, the appropriate hypertext transfer protocol (HTTP) status code indicating the error shall be returned and appropriate additional error information should be returned in the GET response body. Specifically, if there is no valid subscription data for the UE, the HTTP status code “404 Not Found” shall be returned including additional error information in the response body (in the “ProblemDetails” element).

FIG. 2 shows a scenario where the NF service consumer (e.g. SMSF) sends a request to the UDM to receive the UE's SMS management subscription data (see also 3GPP TS 23.502, section 4.13.3.1). At step 1, the NF service consumer (e.g. SMSF) sends a GET request to the resource representing the UE's SMS management subscription data. The request may contain the UE's identity (/{supi}) and the type of the requested information (/sms-mng-data). At step 2, the UDM responds with “200 OK” with the message body containing the UE's SMS management subscription data. The definition about the data type “SmsManagementSubscriptionData” can be obtained from Table 6.1.6.2.14-1 of TS 29.503. On failure, the appropriate HTTP status code indicating the error shall be returned and appropriate additional error information should be returned in the GET response body.

FIG. 3 shows a scenario where the NF service consumer (e.g. SMF) sends a request to the UDM to receive the UE's session management subscription data (see also 3GPP TS 23.502, FIG. 4.3.2.2.1-1, step 4a-4b). At step 1, the NF service consumer (e.g. SMF) sends a GET request to the resource representing the UE's session management subscription data, with query parameters indicating the selected network slice and/or the data network name (DNN) and/or supported-features and/or plmn-id. The request may contain the UE's identity (/{supi}), the type of the requested information (/sm-data), and query parameters (single-nssai, dnn, supported-features, plmn-id). At step 2a, on success, the UDM responds with “200 OK” with the message body containing the UE's session management subscription data as relevant for the requesting NF service consumer. The definition about the data type “SessionManagementSubscriptionData” can be obtained from Table 6.1.6.2.8-1 of TS 29.503. At step 2b, on failure, the appropriate HTTP status code indicating the error shall be returned and appropriate additional error information should be returned in the GET response body. Specifically, if there is no valid subscription data for the UE, or if the UE subscription data exists, but the requested session management subscription is not available (e.g. query parameter contains network slice and/or DNN that does not belong to the UE subscription), the HTTP status code “404 Not Found” shall be returned including additional error information in the response body (in the “ProblemDetails” element).

Because Table 6.1.6.2.4-1, Table 6.1.6.2.14-1 and Table 6.1.6.2.8-1 include no information about the UE's trace requirements, the following requirements of the technical specification cannot be fulfilled:
Tracing requirements about a UE (e.g. trace reference, address of the trace collection entity, etc.) shall be part of access and mobility subscription data, which are needed for UE registration and mobility management but is only sent to AMF in the HPLMN or one of its equivalent PLMN(s).
Tracing requirements shall be part of SMS management subscription data, which are needed by SMSF for SMSF registration but is only sent to a SMSF in the HPLMN.
Tracing requirements shall be part of session management subscription data, which are needed for PDU session establishment but is only sent to a SMF in the HPLMN or one of its equivalent PLMN(s).
   In addition, the corresponding data change notification for trace requirements about UE towards AMF, SMSF and SMF is not supported.

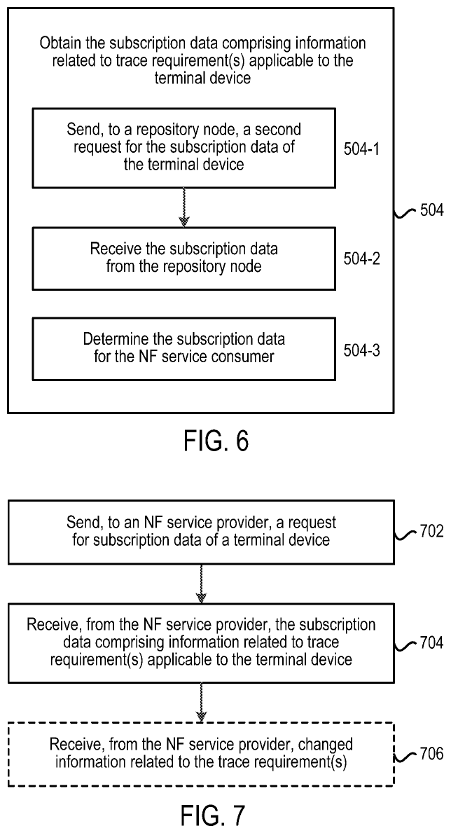

The present disclosure proposes an improved solution for tracing of a terminal device. Hereinafter, the solution will be described in detail with reference to FIGS. 4-14.

FIG. 4 is a diagram showing an exemplary communication system into which an embodiment of the disclosure is applicable. As shown, the communication system comprises a UE, a (R)AN, a user plane function (UPF), a data network (DN), an access and mobility management function (AMF), a session management function (SMF), a policy control function (PCF), an application function (AF), a short message service function (SMSF), a network slice selection function (NSSF), an authentication server function (AUSF), a unified data management (UDM) and a unified data repository (UDR). The functional description of the above entities is specified in clause 6 of 3GPP TS 23.501, which is incorporated herein by reference in its entirety.

Note that the term UE used herein may also be referred to as, for example, terminal device, access terminal, mobile station, mobile unit, subscriber station, or the like. It may refer to any end device that can access a wireless communication network and receive services therefrom. By way of example and not limitation, the UE may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a UE may represent a machine or other device that performs monitoring and/or measurements, and transmits the results of such monitoring and/or measurements to another UE and/or a network equipment. In this case, the UE may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

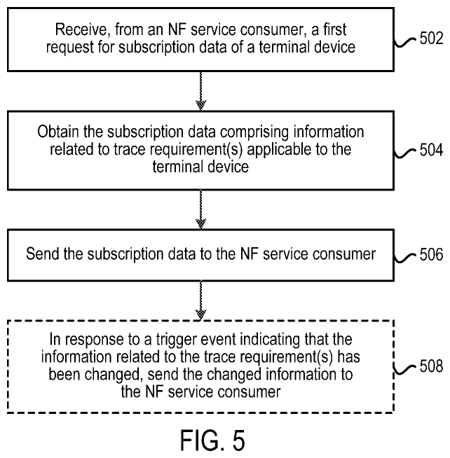

FIG. 5 is a flowchart illustrating a method implemented at an NF service provider according to an embodiment of the disclosure. The NF service provider may be a UDM or any other entity having similar functionality. At block 502, the NF service provider receives, from an NF service consumer, a first request for subscription data of a terminal device. For example, the NF service consumer may be an AMF (or any other entity having similar functionality), an SMSF (or any other entity having similar functionality), an SMF (or any other entity having similar functionality), or the like. The first request may contain the identification information about the terminal device and indicate the type of the requested subscription data. The type of the requested subscription data may be relevant to the NF service consumer. For example, if the NF service consumer is an AMF, it may request access and mobility subscription data of the terminal device. If the NF service consumer is an SMSF, it may request SMS management subscription data of the terminal device. If the NF service consumer is an SMF, it may request session management subscription data of the terminal device. As an exemplary example, the first request may be a GET message.

At block 504, the NF service provider obtains the subscription data. The obtained subscription data comprises information related to trace requirement(s) applicable to the terminal device. As an example, the information related to the trace requirement(s) may comprise at least one trace requirement about the terminal device. As another example, the information related to the trace requirement(s) may comprise an identifier of at least one trace requirement shared among a group of terminal devices including the terminal device. As still another example, a combination of the above two examples is also possible.

As a first option, the subscription data is maintained at a repository node which is separate from the NF service provider. For example, the repository node may be a UDR or any other entity having similar functionality. In this option, block 504 may be implemented as blocks 504-1 and 504-2. At block 504-1, the NF service provider sends, to the repository node, a second request for the subscription data of the terminal device. Similar to the first request, the second request may contain the identification information about the terminal device and indicate the type of the requested subscription data. At block 504-2, the NF service provider receives the subscription data from the repository node.

As a second option, the subscription data is maintained by the NF service provider itself. In this option, block 504 may be implemented as block 504-3. At this block, the NF service provider determines the subscription data for the NF service consumer. This may be done by retrieving the subscription data corresponding to the identification information about the terminal device and the type of the requested subscription data. At block 506, the NF service provider sends the subscription data to the NF service consumer. As an exemplar example, the subscription data may be sent in a “200 OK” message. With the method including blocks 502-506, the subscription data about trace requirement(s) can be provided to fulfill the requirement of the NF service consumer.

Optionally, in response to a trigger event indicating that the information related to the trace requirement(s) has been changed, the NF service provider sends the changed information related to the trace requirement(s) to the NF service consumer at block 508. In the above first option where the subscription data is maintained at the repository node, the trigger event may be a first event that the changed information related to the trace requirement(s) is received from the repository node. In the above second option where the subscription data is maintained by the NF service provider itself, the trigger event may be a second event that the NF service provider determines that the information related to the trace requirement(s) has been changed. As an exemplary example, the changed information related to the trace requirement(s) may be sent in a POST request in both options mentioned above.

FIG. 7 is a flowchart illustrating a method implemented at an NF service consumer according to an embodiment of the disclosure. As described above, the NF service consumer may be an AMF (or any other entity having similar functionality), an SMSF (or any other entity having similar functionality), an SMF (or any other entity having similar functionality), or the like. At block 702, the NF service consumer sends, to an NF service provider, a request for subscription data of a terminal device. Block 702 corresponds to block 502 and its details are omitted here. At block 704, the NF service consumer receives the subscription data from the NF service provider. The received subscription data comprises information related to trace requirement(s) applicable to the terminal device. For example, the information related to the trace requirement(s) may comprise either one or both of: at least one trace requirement about the terminal device; and an identifier of at least one trace requirement shared among a group of terminal devices including the terminal device. As an exemplary example, the subscription data may be received in a “200 OK” message.

Optionally, at block 706, the NF service receives, from the NF service provider, changed information related to the trace requirement(s). In this way, the changed information related to the trace requirement(s) may be used for subsequent tracing of the terminal device. As an exemplary example, the changed information related to the trace requirement(s) may be received in a POST request.

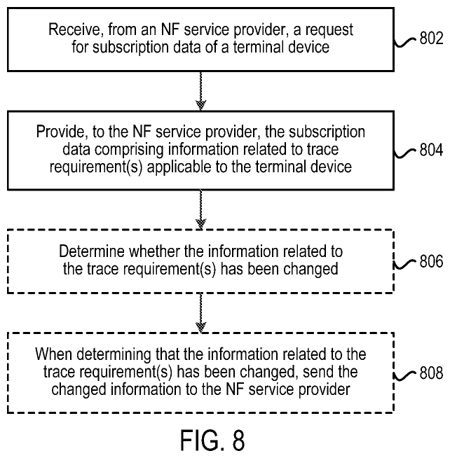

FIG. 8 is a flowchart illustrating a method implemented at a repository node according to an embodiment of the disclosure. As described above, the repository node may be a UDR or any other entity having similar functionality. At block 802, the repository node receives, from an NF service provider, a request for subscription data of a terminal device. Block 802 corresponds to block 504-1 and its details are omitted here. At block 804, the repository node provides the subscription data to the NF service provider. The provided subscription data comprises information related to trace requirement(s) applicable to the terminal device. For example, the information related to the trace requirement(s) may comprise either one or both of: at least one trace requirement about the terminal device; and an identifier of at least one trace requirement shared among a group of terminal devices including the terminal device. The subscription data may be provided by retrieving the subscription data according to the received request and sending the retrieved subscription data to the NF service provider.

Optionally, at block 806, the repository node determines whether the information related to the trace requirement(s) has been changed. If it is determined that the information related to the trace requirement(s) has been changed, the repository node sends the changed information related to the trace requirement(s) to the NF service provider at block 808.

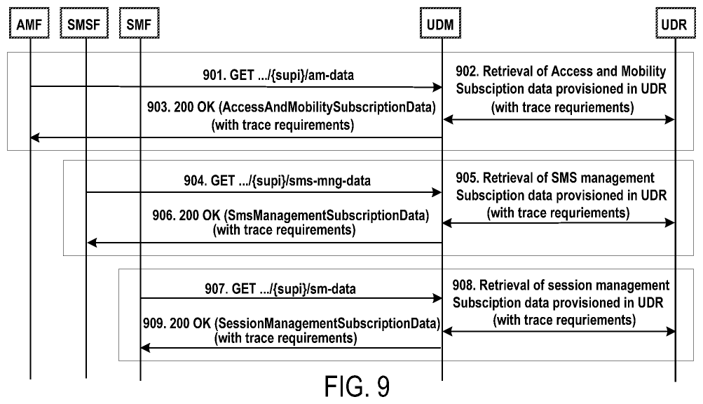

FIG. 9 is a flowchart illustrating an exemplary process according to an embodiment of the disclosure. It shows the retrieval of a UE's Access and Mobility Subscription data by an AMF, the retrieval of a UE's SMS Management Subscription data by an SMSF and the retrieval of a UE's Session Management Subscription data by an SMF. In this exemplary process, suppose the UDM is a stateless UDM and thus the subscription data is maintained at the UDR. Compared with the existing processes shown in FIGS. 1-3, the main difference is that trace requirements about the UE is returned together with other subscription data corresponding to the UE.

At block 901, the NF service consumer (e.g. the AMF) sends a GET request to the resource representing the UE's Access and Mobility Subscription Data, with query parameters indicating the supported-features and/or plmn-id. At block 902, the UDM queries the UDR where the requested access and mobility subscription data is provisioned. If existing, the trace requirement data about the UE is also returned. At block 903, the UDM responds with “200 OK” with the message body containing the UE's Access and Mobility Subscription Data as relevant for the requesting NF service consumer. The UDM also adds the trace requirements about the UE relevant to AMF NF in the response.

Correspondingly, the protocol data may be modified to support the above process. The following Table 1 shows the updated Table 6.1.6.2.4-1 of TS 29.503 V15.3.0 with the proposed modifications being underlined. The definition of the type TraceData can be obtained from Table 5.6.4.1-1 of 3GPP TS 29.571 V15.3.0, which is incorporated herein by reference in its entirety.

TABLE 1
Definition of type AccessAndMobilitySubscriptionData

| Attribute name | Data type | P | Cardinality | Description |
|---|---|---|---|---|
| supportedFeatures | SupportedFeatures | O | 0 . . . 1 | See subclause 6.1.8 |
| gpsis | array(Gpsi) | O | 0 . . . N | List of Generic Public Subscription Identifier; see |
| | | | | 3GPP TS 29.571 [7] |
| internalGroupIds | array(GroupId) | O | 1 . . . N | List of internal group identifier; see |
| | | | | 3GPP TS 23.501 [2] subclause 5.9.7 |
| subscribedUeAmbr | AmbrRm | O | 0 . . . 1 | |
| nssai | Nssai | O | 0 . . . 1 | Network Slice Selection Assistance Information |
| ratRestrictions | array(RatType) | O | 0 . . . N | List of RAT Types that are restricted; see |
| | | | | 3GPP TS 29.571 [7] |
| forbiddenAreas | array(Area) | O | 0 . . . N | List of forbidden areas |
| serviceAreaRestriction | ServiceAreaRestriction | O | 0 . . . 1 | Subscribed Service Area Restriction |
| coreNetworkTypeRestrictions | array(CoreNetworkType) | O | 0 . . . N | List of Core Network Types that are restricted |
| rfspIndex | RfspIndexRm | O | 0 . . . 1 | Index to RAT/Frequency Selection Priority; |
| subsRegTimer | DurationSecRm | O | 0 . . . 1 | Subscribed periodic registration timer; see |
| | | | | 3GPP TS 29.571 [7] |
| ueUsageType | UeUsageType | O | 0 . . . 1 | |
| mpsPriority | MpsPriorityIndicator | O | 0 . . . 1 | |
| mcsPriority | McsPriorityIndicator | O | 0 . . . 1 | |
| activeTime | DurationSecRm | O | 0 . . . 1 | subscribed active time for PSM UEs |
| dlPacketCount | DlPacketCount | O | 0 . . . 1 | DL Buffering Suggested Packet Count indicates |
| | | | | whether extended buffering of downlink packets |
| | | | | for High Latency Communication is requested. |
| sorInfo | SorInfo | O | 0 . . . 1 | On Nudm, this IE shall be present if the UDM shall |
| | | | | send the information for Steering of Roaming |
| | | | | during registration or the subscription data update |
| | | | | to the UE. The UDM may detect the need to send |
| | | | | sorInfo by retrieving context information from the |
| | | | | UDR. |
| upuInfo | UpuInfo | O | 0 . . . 1 | This IE shall be present if the UDM shall send the |
| | | | | information for UE Parameters Update after the |
| | | | | UE has been successfully authenticated and |
| | | | | registered to the 5G system. |
| micoAllowed | MicoAllowed | O | 0 . . . 1 | Indicates whether the UE subscription allows |
| | | | | MICO mode. |
| sharedAmDataIds | array(SharedDataId) | O | 0 . . . N | Identifier of shared Access And Mobility |
| | | | | Subscription data |
| odbPacketServices | OdbPacketServices | O | 0 . . . 1 | Operator Determined Barring for Packet Oriented |
| | | | | Services |
| subscribedDnnList | array(Dnn) | O | 0 . . . N | List of the subscribed DNNs for the UE. Used to |
| | | | | determine the list of LADN available to the UE as |
| | | | | defined in clause 5.6.5 of TS 23.501 [2]. |
| traceData | TraceData | O | 0 . . . 1 | Trace requirements about the UE |
| sharedTraceDataIds | SharedDataId | O | 0 . . . 1 | Identifier of shared data for trace requirements |

NOTE:
AccessAndMobilitySubscriptionData can be UE-individual data or shared data.
UE-individual data take precedence over shared data.
E.g.: When an attribute of type array is present but empty within UE-Individual data and present (with any cardinality) in shared data, the empty array takes precedence. Similarly, when a nullable attribute is present with value null within the individual data and present (with any value) in shared data, the null value takes precedence (i.e. for the concerned UE the attribute is considered absent).

At block 904, the NF service consumer (e.g. the SMSF) sends a GET request to the resource representing the UE's SMS Management Subscription Data. At block 905, the UDM queries the UDR where the requested SMS management subscription data is provisioned. If existing, the trace requirement data about the UE is also returned. At block 906, the UDM responds with “200 OK” with the message body containing the UE's SMS Management Subscription Data as relevant for the requesting NF service consumer. The UDM also adds the trace requirements about the UE relevant to SMSF NF in the response.

Correspondingly, the protocol data may be modified to support the above process. The following Table 2 shows the updated Table 6.1.6.2.14-1 of TS 29.503 with the proposed modifications being underlined.

TABLE 2
Definition of type SmsManagementSubscriptionData

| Attribute name | Data type | P | Cardinality | Description |
|---|---|---|---|---|
| supportedFeatures | SupportedFeatures | O | 0 . . . 1 | See subclause 6.1.8 |
| mtSmsSubscribed | boolean | C | 1 | Indicates the SMS teleservice subscription for MT- |
| | | | | SMS. Shall not be absent unless the feature |
| | | | | SharedData is supported and mtSmsSubscribed |
| | | | | is present within shared data. |
| mtSmsBarringAll | boolean | C | 0 . . . 1 | Barring of all MT-SMS |
| mtSmsBarringRoaming | boolean | C | 0 . . . 1 | Barring of MT-SMS when roaming outside the |
| | | | | Home Public Land Mobile Network (PLMN) |
| | | | | country |
| moSmsSubscribed | boolean | C | 1 | Indicates the SMS teleservice subscription for |
| | | | | MO-SMS. Shall not be absent unless the feature |
| | | | | SharedData is supported and mtSmsSubscribed |
| | | | | is present within shared data. |
| moSmsBarringAll | boolean | C | 0 . . . 1 | Barring of all MO-SMS |
| moSmsBarringRoaming | boolean | C | 0 . . . 1 | Barring of MO-SMS when roaming outside the |
| | | | | Home Public Land Mobile Network (PLMN) |
| | | | | country |
| traceData | TraceData | O | 0 . . . 1 | Trace requirements about the UE |
| sharedSmsMngDataIds | array(SharedDataId) | C | 1 . . . N | Identifier of shared data. Shall be present if |
| | | | | mtSmsSubscribed and/or moSmsSubscribed |
| | | | | and/or traceData are absent. |

At block 907, the NF service consumer (e.g. the SMF) sends a GET request to the resource representing the UE's Session Management Subscription Data, with query parameters indicating the selected network slice and/or the DNN and/or supported-features and/or plmn-id. At block 908, the UDM queries the UDR where the requested session management subscription data is provisioned. If existing, the trace requirement data about the UE is also returned. At block 909, the UDM responds with “200 OK” with the message body containing the UE's Session Management Subscription Data as relevant for the requesting NF service consumer. The UDM also adds the trace requirements about the UE relevant to SMF NF in the response.

Correspondingly, the protocol data may be modified to support the above process. The following Table 3 shows the updated Table 6.1.6.2.8-1 of TS 29.503 with the proposed modifications being underlined.

TABLE 3
Definition of type SessionManagementSubscriptionData

| Attribute name | Data type | P | Cardinality | Description |
|---|---|---|---|---|
| singleNssai | Snssai | M | 1 | A single Network Slice Selection Assistance |
| | | | | Information |
| dnnConfigurations | map(DnnConfiguration) | O | 0 . . . N | Additional DNN configurations for the |
| | | | | network slice; |
| | | | | A map (list of key-value pairs where dnn |
| | | | | serves as key; see subclause 6.1.6.1) of |
| | | | | DnnConfigurations. |
| internalGroupIds | array(GroupId) | O | 1 . . . N | List of internal group identifier; see |
| | | | | 3GPP TS 23.501 [2] subclause 5.9.7 |
| traceData | TraceData | O | 0 . . . 1 | Trace requirements about the UE |
| sharedDnnConfigurationsId | SharedDataId | O | 1 . . . 0 | Identifier of shared data. |
| sharedTraceData | SharedDataId | O | 0 . . . 1 | Identifier of shared data for trace |
| | | | | requirements |

NOTE:
A single UE-individual dnnConfiguration (within dnnConfigurations) may clash with a shared dnnConfiguration (i.e. both have the same dnn value as key). In this case the UE-individual dnnConfiguration takes precedence.

With the process described above for the subscription data retrieval, trace requirements about a UE can be managed by the UDM subscription data management service to fulfill customer basic requirements on trace requirement data relevant to an AMF, an SMSF and an SMF.

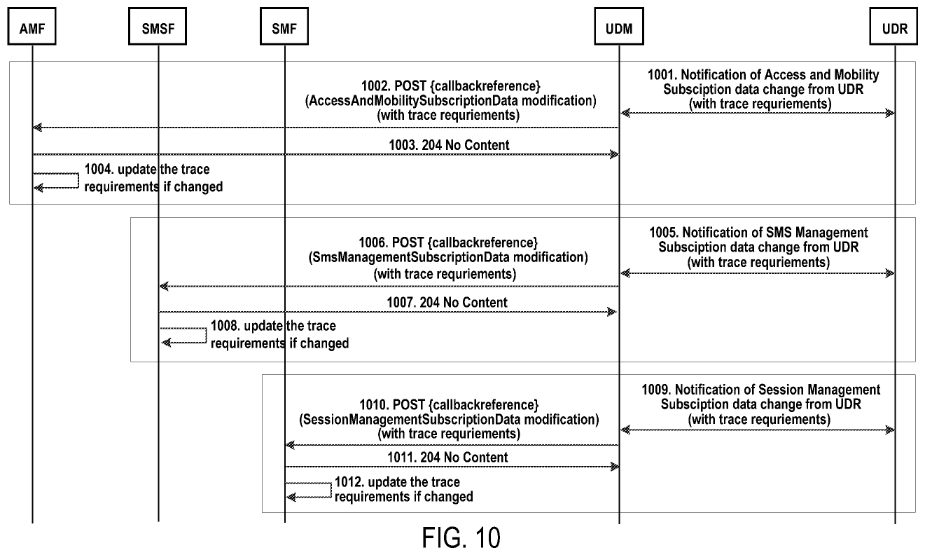

FIG. 10 is a flowchart illustrating another exemplary process according to an embodiment of the disclosure. It shows the data change notification of a UE's Access and Mobility Subscription data towards an AMF, the data change notification of a UE's SMS Management Subscription data towards an SMSF and the data change notification of a UE's Session Management Subscription data towards an SMF. Compared with the existing data change notification, the main difference is that trace requirements about the UE (if changed) is also returned together with other subscription data modification corresponding to the UE.

At block 1001, the UDR notifies the UDM about the data change of the Access and Mobility subscription data, triggered by the update of the provisioned trace requirements about the UE for the AMF. At block 1002, the UDM sends a POST request to the callbackReference as provided by the AMF during the subscription. In this way, when trace requirement data about the UE changed, the UDM notifies the updated trace requirements about the UE relevant to AMF NF in the notification of access and mobility subscription data modification. The Access and Mobility subscription data modification for trace requirements about the UE is contained in the request body. At block 1003, the NF service consumer (i.e. the AMF) responds with “204 No Content” for acknowledgement. At block 1004, the AMF may update the local cached trace requirements about the UE.

At block 1005, the UDR notifies the UDM about the data change of the SMS management subscription data, triggered by the update of the provisioned trace requirements about the UE for the SMSF. At block 1006, the UDM sends a POST request to the callbackReference as provided by the SMSF during the subscription. In this way, when trace requirement data about the UE changed, the UDM notifies the updated trace requirements about the UE relevant to the SMSF NF in the notification of SMS management subscription data modification. The SMS management subscription data modification for trace requirements about the UE is contained in the request body. At block 1007, the NF service consumer (i.e. the SMSF) responds with “204 No Content” for acknowledgement. At block 1008, the SMSF may update the local cached trace requirements about the UE, which was, for example, propagated from the AMF previously. The Trace requirements received from the UDM supersede Trace requirements received from the AMF.

At block 1009, the UDR notifies the UDM about the data change of the session management subscription data, triggered by the update of the provisioned trace requirements about the UE for the SMF. At block 1010, the UDM sends a POST request to the callbackReference as provided by SMF during the subscription. In this way, when trace requirement data about the UE changed, the UDM notifies the updated trace requirements about the UE relevant to SMF NF in the notification of session management subscription data modification. The session management subscription data modification for trace requirements about the UE is contained in the request body. At block 1011, the NF service consumer (i.e. the SMF) responds with “204 No Content” for acknowledgement. At block 1012, the SMF may update the local cached trace requirements about the UE, which was, for example, propagated from the AMF previously. The Trace requirements received from the UDM supersede the Trace requirements received from the AMF.

With the process described above for the subscription data change notification, changes of trace requirements can be notified to relevant NFs (e.g. AMF, SMSF, SMF) within the notification of access and mobility subscription data modification, the notification of SMS management subscription data modification, the notification of session management subscription data modification correspondingly. It should be noted that two blocks shown in succession in the figures may, in fact, be executed substantially concurrently, or the blocks may sometimes be executed in the reverse order, depending upon the functionality involved.

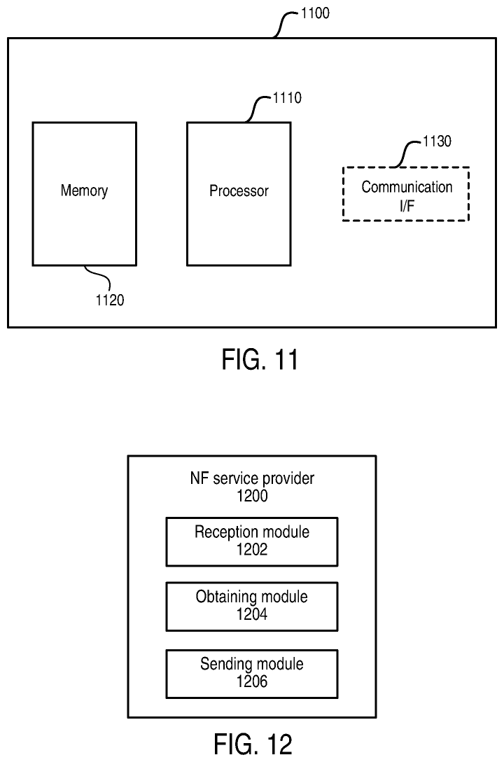

FIG. 11 is a block diagram showing an apparatus suitable for use in practicing some embodiments of the disclosure. For example, any one of the NF service provider, the NF service consumer and the repository node described above may be implemented through the apparatus 1100. As shown, the apparatus 1100 may include a processor 1110, a memory 1120 that stores a program, and optionally a communication interface 1130 for communicating data with other external devices through wired and/or wireless communication.

The program includes program instructions that, when executed by the processor 1110, enable the apparatus 1100 to operate in accordance with the embodiments of the present disclosure, as discussed above. That is, the embodiments of the present disclosure may be implemented at least in part by computer software executable by the processor 1110, or by hardware, or by a combination of software and hardware.

The memory 1120 may be of any type suitable to the local technical environment and may be implemented using any suitable data storage technology, such as semiconductor based memory devices, flash memories, magnetic memory devices and systems, optical memory devices and systems, fixed memories and removable memories. The processor 1110 may be of any type suitable to the local technical environment, and may include one or more of general purpose computers, special purpose computers, microprocessors, digital signal processors (DSPs) and processors based on multi-core processor architectures, as non-limiting examples.

FIG. 12 is a block diagram showing an NF service provider according to an embodiment of the disclosure. As shown, the NF service provider 1200 comprises a reception module 1202, an obtaining module 1204 and a sending module 1206. The reception module 1202 may be configured to receive, from an NF service consumer, a first request for subscription data of a terminal device, as described above with respect to block 502. The obtaining module 1204 may be configured to obtain the subscription data, as described above with respect to block 504. The subscription data comprises information related to trace requirement(s) applicable to the terminal device. The sending module 1206 may be configured to send the subscription data to the NF service consumer, as described above with respect to block 506.

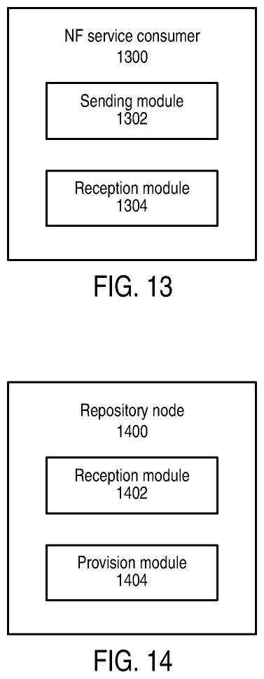

FIG. 13 is a block diagram showing an NF service consumer according to an embodiment of the disclosure. As shown, the NF service consumer 1300 comprises a sending module 1302 and a reception module 1304. The sending module 1302 may be configured to send, to an NF service provider, a request for subscription data of a terminal device, as described above with respect to block 702. The reception module 1304 may be configured to receive the subscription data from the NF service provider, as described above with respect to block 704. The subscription data comprises information related to trace requirement(s) applicable to the terminal device.

FIG. 14 is a block diagram showing a repository node according to an embodiment of the disclosure. As shown, the repository node 1400 comprises a reception module 1402 and a provision module 1404. The reception module 1402 may be configured to receive, from an NF service provider, a request for subscription data of a terminal device, as described above with respect to block 802. The provision module 1404 may be configured to provide the subscription data to the NF service provider, as described above with respect to block 804. The subscription data comprises information related to trace requirement(s) applicable to the terminal device. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method in a network function, NF, service provider comprising:
receiving, from an NF service consumer, a first request for subscription data of a terminal device;
obtaining the subscription data, wherein the subscription data comprises information related to trace requirement(s) applicable to the terminal device; and
sending the subscription data to the NF service consumer.

2. The method according to claim 1, wherein the information related to the trace requirement(s) comprises at least one trace requirement about the terminal device.

3. The method according to claim 1, wherein the information related to the trace requirement(s) comprises an identifier of at least one trace requirement shared among a group of terminal devices including the terminal device.

4. The method according to claim 1, further comprising:
in response to a trigger event indicating that the information related to the trace requirement(s) has been changed, sending the changed information related to the trace requirement(s) to the NF service consumer.

5. The method according to claim 1, wherein obtaining the subscription data comprises:
sending, to a repository node, a second request for the subscription data of the terminal device; and
receiving the subscription data from the repository node.

6. The method according to claim 5, wherein the trigger event is a first event that the changed information related to the trace requirement(s) is received from the repository node.

7. The method according to claim 1, wherein obtaining the subscription data comprises: determining the subscription data for the NF service consumer.

8. The method according to claim 7, wherein the trigger event is a second event that the NF service provider determines that the information related to the trace requirement(s) has been changed.

9. The method according to claim 1, wherein the first request is a GET message and the subscription data is sent in a “200 OK” message.

10. The method according to claim 4, wherein the changed information related to the trace requirement(s) is sent in a POST request.

11. The method according to claim 5, wherein the repository node is a unified data repository, UDR.

12. The method according to claim 1, wherein the NF service consumer is one of: an access and mobility management function, AMF; a short message service function, SMSF; and a session management function, SMF.

13. The method according to claim 1, wherein the NF service provider is a unified data management, UDM.

14. A method in a network function, NF, service consumer comprising:
sending, to an NF service provider, a request for subscription data of a terminal device; and
receiving the subscription data from the NF service provider, wherein the subscription data comprises information related to trace requirement(s) applicable to the terminal device.

15. The method according to claim 14, wherein the information related to the trace requirement(s) comprises at least one trace requirement about the terminal device.

16. The method according to claim 14, wherein the information related to the trace requirement(s) comprises an identifier of at least one trace requirement shared among a group of terminal devices including the terminal device.

17. The method according to claim 14, further comprising:
receiving, from the NF service provider, changed information related to the trace requirement(s).

18-27. (canceled)

28. A network function, NF, service provider comprising:
at least one processor; and
at least one memory, the at least one memory containing instructions executable by the at least one processor to:
receive, from an NF service consumer, a first request for subscription data of a terminal device;
obtain the subscription data, wherein the subscription data comprises information related to trace requirement(s) applicable to the terminal device; and
send the subscription data to the NF service consumer.

29-34. (canceled)

35. The NF service provider according to claim 28, wherein the information related to the trace requirement(s) comprises at least one trace requirement about the terminal device.

36. The NF service provider according to claim 28, wherein the information related to the trace requirement(s) comprises an identifier of at least one trace requirement shared among a group of terminal devices including the terminal device.

37. The NF service provider according to claim 28, wherein the instructions are further configured to cause the at least one processor to:
in response to a trigger event indicating that the information related to the trace requirement(s) has been changed, sending the changed information related to the trace requirement(s) to the NF service consumer.

38. The NF service provider according claim 28, wherein obtaining the subscription data comprises:
sending, to a repository node, a second request for the subscription data of the terminal device; and
receiving the subscription data from the repository node.

39. The NF service provider according to claim 38, wherein the trigger event is a first event that the changed information related to the trace requirement(s) is received from the repository node.

40. The NF service provider according to claim 28, wherein to obtain the subscription data comprises: determining the subscription data for the NF service consumer.

41. The NF service provider according to claim 40, wherein the trigger event is a second event that the NF service provider determines that the information related to the trace requirement(s) has been changed.

42. The NF service provider according to claim 28, wherein the first request is a GET message and the subscription data is sent in a “200 OK” message.
